(19) United States
(12) Patent Application Publication
(10) Pub. No.: US 2010/0080357 A1
(43) Pub. Date: Apr. 1, 2010

(54) WIDE COVERAGE X-RAY TUBE AND CT SYSTEM

(75) Inventors: Jason Stuart Katcha, Whitefish Bay, WI (US); Thomas Louis Toth, Brookfield, WI (US); Jiang Hsieh, Brookfield, WI (US); Carey Shawn Rogers, Brookfield, WI (US); John Scott Price, Niskayuna, NY (US); Baojun Li, Waukesha, WI (US); Yun Zou, Clifton Park, NY (US)

Correspondence Address: PETER VOGEL;GE HEALTHCARE, 20225 WATER TOWER BLVD., MAIL STOP W492, BROOKFIELD, WI, 53045, US

(73) Assignee: GENERAL ELECTRIC COMPANY, Schenectady, NY (US)

(21) Appl. No.: 12/243,610

(22) Filed: Oct. 1, 2008

(51) Int. Cl. H01J 35/10; H01J 35/08

(52) U.S. Cl. 378/124; 378/144

(57) ABSTRACT

An x-ray tube is disclosed herein. The x-ray tube includes an anode assembly adapted to rotate generally about a rotational axis. The anode assembly includes a first target surface at least partially disposed at a first angle greater than 70 degrees with respect to the rotational axis and a second target surface at least partially disposed at a second angle greater than 70 degrees with respect to the rotational axis. The first target surface is adapted to emit a first x-ray beam and the second target surface is adapted to emit a second x-ray beam. A CT system is also disclosed.

### FIELD OF THE INVENTION

This disclosure relates generally to an x-ray tube and a CT system with multiple target surfaces.

### BACKGROUND OF THE INVENTION

Typically, in a computed tomography system or CT system, an x-ray tube emits a fan-shaped x-ray beam or a cone-beam shaped x-ray beam toward a subject or object positioned on a table. The beam, after being attenuated by the subject, impinges upon a detector assembly. The intensity of the attenuated x-ray beam received at the detector assembly is typically dependent upon the attenuation of the x-ray beam by the subject. Each detector element of the detector assembly produces a separate electrical signal indicative of the attenuated x-ray beam received.

In known third generation CT systems, the x-ray source and the detector assembly are rotated on a gantry around the object to be imaged so that a gantry angle at which the fan-shaped or cone-shaped x-ray beam intersects the object constantly changes. The table supporting the subject may be advanced while the gantry is rotating around the object being imaged. Data representing the strength of the received x-ray beam at each of the detector elements is collected across a range of gantry angles. The data are ultimately reconstructed to form an image of the object.

For third generation CT systems, it is advantageous to have a large field-of-view for certain procedures. For example, a large field-of-view allows for the collection of data in fewer gantry revolutions, which leads to a quicker acquisition time. Typically, manufacturers of CT systems have increased the size of the field-of-view in a z-direction by increasing the width of the detector assembly. However, a conventional CT system with a single x-ray source and a wide detector assembly may have to overcome limitations caused by a cone-beam artifact for wide detector assemblies. Also, the width of the field-of-view is typically significantly narrower than the width of the detector assembly, which may lead to exposing the subject to x-ray dose that does not contribute to the formation of the image. Additionally, a wide detector represents a significant increase in the cost of the CT system. For these and other reasons, an alternate solution for providing a wider field-of-view in a CT system is desired.

### BRIEF DESCRIPTION OF THE INVENTION

The above-mentioned shortcomings, disadvantages and problems are addressed herein which will be understood by reading and understanding the following specification.

In an embodiment, an x-ray tube includes an anode assembly adapted to rotate generally about a rotational axis. The anode assembly includes a first target surface at least partially disposed at a first angle greater than 70 degrees with respect to the rotational axis and a second target surface at least partially disposed at a second angle greater than 70 degrees with respect to the rotational axis. The first target surface is adapted to emit a first x-ray beam and the second target surface is adapted to emit a second x-ray beam.

In an embodiment, a CT system includes a gantry, a detector assembly mounted to the gantry, and an x-ray tube mounted to the gantry generally across from the detector assembly. The x-ray tube includes an anode assembly adapted to rotate generally about a rotational axis. The anode assembly includes a first target surface at least partially disposed at a first angle between 70 and 88 degrees with respect to the rotational axis and a second target surface at least partially disposed at a second angle between 70 and 88 degrees with respect to the rotational axis. The first target surface is adapted to emit a first x-ray beam and the second target surface is adapted to emit a second x-ray beam.

Various other features, objects, and advantages of the invention will be made apparent to those skilled in the art from the accompanying drawings and detailed description thereof.

### BRIEF DESCRIPTION OF THE DRAWINGS

FIG. 1 is a schematic diagram illustrating a computed tomography system in accordance with an embodiment;

FIG. 2 is a schematic diagram illustrating an x-ray tube in accordance with an embodiment; and

FIG. 3 is a schematic diagram illustrating an x-ray tube in accordance with an embodiment.

### DETAILED DESCRIPTION OF THE INVENTION

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken as limiting the scope of the invention.

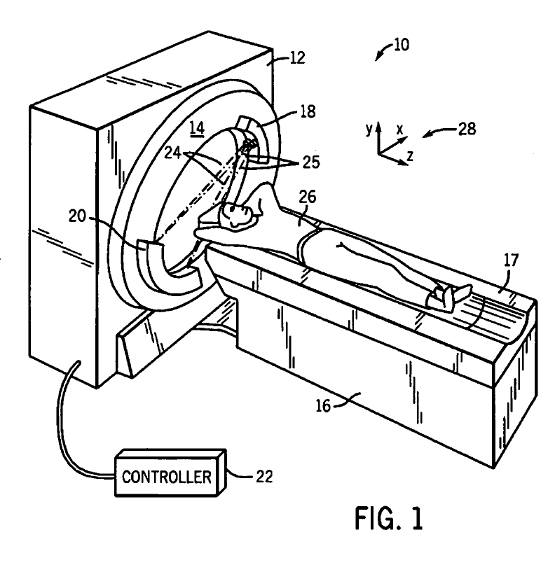

Referring to FIG. 1, a schematic representation of a computed tomography system or CT system 10 according to an embodiment is shown. The CT system 10 includes a gantry support 12, a gantry 14, a table 16, a moveable table portion 17, an x-ray tube 18, a detector assembly 20, and a controller 22. The gantry 14 is configured to rotate within the gantry support 12. The gantry 14 is adapted to retain the x-ray tube 18 and the detector assembly 20. The x-ray tube 18 is configured to emit a first x-ray beam 24 and a second x-ray beam 25 towards the detector assembly 20. The detector assembly 20 comprises a plurality of detector elements (not shown). Each of the plurality of detector elements produces an electrical signal that varies based on the intensity of the first or second x-ray beam 24, 25 received during a sampling interval. The table 16 is configured to support a subject or object 26 being scanned. The moveable table portion 17 is capable of translating the subject 26 in a z-direction with respect to the gantry 14 as indicated by a coordinate axis 28. The controller 22 is configured to control the rotation of the gantry 14, the translation of the moveable table portion 17, and the activation of the x-ray tube 18.

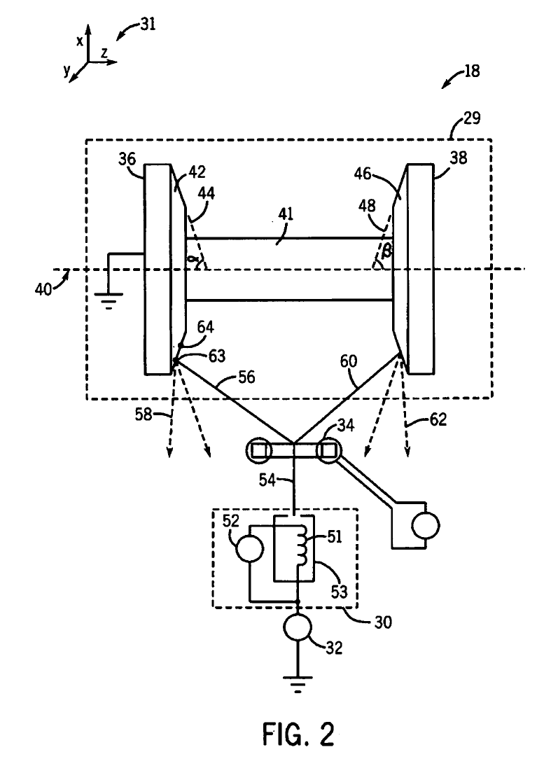

FIG. 2 is a schematic illustration of the x-ray tube 18 in accordance with an embodiment. Common reference numbers are used to identify components that are generally identical to those in FIG. 1. The x-ray tube 18 includes an anode assembly 29, an electron source 30, a high-voltage power supply 32, and an electromagnet 34. According to an embodiment, the anode assembly 29 comprises a first anode 36 and a second anode 38. The first anode 36 and the second anode 38 are both configured to rotate about a rotational axis 40. According to an embodiment, a shaft 41 rigidly connects the first anode 36 to the second anode 38. According to another embodiment, the first anode 36, the second anode 38, and the shaft 41 could all be replace by a single integral component. Also, it should be appreciated that additional embodiments may comprise a plurality of discrete anodes that are spaced apart and not connected by a shaft.

The first anode 36 and the second anode 38 are made from a material designed to emit x-rays when bombarded with electrons. One such material is tungsten, but many other materials may be used as is well-known by those skilled in the art. The first anode 36 is shaped to define a first target surface 42 that is designed to be hit by electrons in order to emit a plurality of x-rays. According to an embodiment, the first anode 36 is shaped so the first target surface 42 is at a first angle a with respect to the rotational axis 40 as indicated by a first dashed line 44 that is tangential to the first target surface 42.

The second anode 38 is shaped to define a second target surface 46 that is also designed to be hit by electrons in order to emit a plurality of x-rays. The second anode 38 is displaced in the z-direction from the first anode 36 as indicated by a coordinate axis 31. In a manner similar to the first anode 36, the second anode 38 is shaped so the second target surface 46 is at a second angle β with respect to the rotational axis 40 as indicated by a second dashed line 48 that is tangential to the second target surface 46.

According to other embodiments, a first anode could be shaped so that a first target surface is disposed at plurality of angles with respect to a rotational axis and/or a second anode could be shaped so that a second target surface is disposed at a plurality of angles with respect to the rotational axis. For embodiments where the first target surface is disposed at a plurality of angles with respect to the rotational axis, at least a portion of the first target surface may be disposed at a first angle greater than 70 degrees with respect to a rotational axis. Likewise, for embodiments where the second target surface is disposed at a plurality of angles with respect to the rotational axis, at least a portion of the second target surface may be disposed at a first angle greater than 70 degrees with respect to a rotational axis. According to other embodiments, a first anode may be tapered in a generally linear manner or in both a generally curved manner and a generally linear manner to define a first target surface and/or a second anode may be tapered in generally linear manner or in both a generally curved manner and a generally linear manner.

According to the embodiment shown in FIG. 2, the first angle α and the second angle β are both approximately 80 degrees. According to other embodiments, the first angle α may differ from the second angle β. For example, the first target surface 42 and the second target surface 46 may each be disposed at a different angle from the range of 70 degree to 90 degrees with respect to the rotational axis 40.

Still referring to FIG. 2, the electron source 30 comprises a filament 51, a current source 52, and a focusing electrode 53. The electron source 30 is connected to the high-voltage power supply 32. The filament 51 is indirectly heated by the current source 52 which causes the filament 51 to emit a plurality of electrons. A high negative voltage is applied to the electron source 30 from the high-voltage power supply 32. The focusing electrode 53 provides an electric field that accelerates the plurality of electrons. According to the embodiment shown in FIG. 2, the plurality of electrons form an electron beam 54 that may be directed toward either the first target surface 42 or the second target surface 46. It should be appreciated that an electron source of a different design may be used according to additional embodiments.

According to an embodiment, the electron source 30 may be configured to emit the electron beam 54 at multiple kinetic energy levels. For example, the electron source 30 may emit the electron beam 54 at a first kinetic energy level during a portion of a scan and at a second kinetic energy level during a different portion of the scan. The energy level of the x-rays produced when the electron beam 54 contacts either the first target surface 42 or the second target surface 46 depends on the kinetic energy level of the electron beam 54. For example, when the electron beam 54 is at a first kinetic energy level, it will produce x-rays of a first energy level. Likewise, when the electron beam 54 is at a second kinetic energy level, it will produce x-rays of a second energy level. By acquiring data with x-rays at both the first x-ray energy level and the second x-ray energy level, it is possible to get additional insight into the materials of the object 26 (shown in FIG. 1) being scanned. Also, according to additional embodiments, the electron source 30 may be configured to produce the electron beam 54 at more than two different kinetic energy levels.

The electro-magnet 34 is positioned between the electron source 30 and the target surfaces 42, 46, and the electromagnet 34 is configured to generate an electromagnetic field when energized with an electrical current. The electron beam 54 generated by the electron source 30 travels through the electromagnetic field created by the electro-magnet 34. By adjusting the electrical current traveling through the electro-magnet 34, the path of the electron beam 54 can be adjusted as is well-known by those skilled in the art. For example, the electromagnet 34 is configured to cause the electron beam 54 to change direction and follow a first path 56 so the electron beam 54 contacts the first target surface 42. A percentage of the electrons in the electron beam 54 will interact with the first target surface 42, forming a first x-ray beam 58 that is emitted toward the detector assembly 20 (shown in FIG. 1). According to an embodiment, the electromagnet 34 may also be used to spread out the electron beam 54 so that the electron beam 54 contacts a larger area of the first target surface 42 or a larger area of the second target surface 46.

Still referring to FIG. 2, the electromagnet 34 is also configured to cause the electron beam 54 to change direction and follow a second path 60 so the electron beam 54 contacts the second target surface 46 of the second anode 38. In manner similar to that described above, a percentage of the electrons in the electron beam 54 will interact with the second target surface 46, forming a second x-ray beam 62 that is emitted toward the detector assembly 20 (shown in FIG. 1). According to an embodiment, the direction that the electrical current flows in the electro-magnet 34 is rapidly switched so that the electron beam 54 transitions between the first target surface 42 and the second target surface 46. For example, according to an embodiment, the electromagnet 34 may be configured to cause the electron beam 54 to follow the first path 56 and contact the first target surface 42 for approximately 100 μS. Then, the electromagnet 34 may spend approximately 5 μS transitioning the electron beam 54 from the first path 56 to the second path 60. And then the electromagnet 34 may cause the electron beam 54 to spend approximately 100 μS following the second path 60 and contacting the second target surface 46.

When the electron beam 54 follows the first path 56, the first x-ray beam 58 is generated. When the electron beam 54 follows the second path 60, the second x-ray beam 62 is generated. The electromagnet 34 may cause the electron beam 54 to oscillate between the first target surface 42 and the second target surface 46 hundreds or thousands of times during a single scan. By alternating between acquiring data with the first x-ray beam 58 and acquiring data with the second x-ray beam 62, it is possible to acquire data corresponding to a field-of-view that is wider in the z-direction. It should be appreciated that the electromagnet 34 may cause the electron beam 54 to transition from the first target surface 42 to the second target surface 46 according to a different control scheme. For example, according to an embodiment, the electron beam 54 may spend a different amount of time on either the first target surface 42 or the second target surface 46. Additionally, the electron beam 54 may transition between the first target surface 42 and the second target surface 46 in either more or less time than 5 μS.

According to another embodiment, the electro-magnet 34 may be configured to move the electron beam 54 so that it oscillates between contacting a first position 63 and a second position 64 on the first target surface 42. The first x-ray beam 58 will originate from the position where the electron beam 54 contacts the first target surface 42. Since the first position 63 is displaced from the second position 64 in the z-direction, causing the electron beam 54 to oscillate between the first position 63 and the second position 64 on the first target surface 42 may permit the acquisition of CT data with higher resolution in the z-direction. This technique is sometimes referred to as z-wobbling. According to additional embodiments, it would also be possible to perform z-wobbling when the electron beam 54 is contacting the second target surface 46 of the second anode 38 in a similar manner to that described above for when the electron beam 54 is contacting first target surface 42.

Still referring to FIG. 2, the first angle α of the first target surface 42, the second angle β of the second target surface 46 and the spacing between the first target surface 42 and the second target surface 46 may be selected in order to optimize multiple parameters. Parameters that may be considered include an amount of the first and second target surfaces 42, 46 that are contacted by the electon beam 54 and a heel effect.

There is a desire to have the electron beam 54 contact a larger portion of the first target surface 42 in order to avoid overheating the first anode 36. Since the first target surface 42 is disposed at the first angle α with respect to the rotational axis 40, it is possible to have the electron beam 54 contact an area of the first target surface 42 that is longer than the width of a focal spot of the x-ray beam 58 in the z-direction. However, it may not be desirable for the first angle α to be too close to 90 degrees because the heel effect may cause the first x-ray beam 58 to vary in intensity in the z-direction. It should be appreciated that while the this paragraph described the first angle α, the same logic may be applied to the second angle β of the second target surface 46.

Therefore, it has been determined that having a first target surface 42 and a second target surface 46 each at least partially disposed at an angle of 70 to 88 degrees, or more specifically, 75 to 85 degrees with respect to an axis of rotation may yield an effective compromise between the need to spread an electron beam over a larger portion of a target surface and the need to minimize the heel effect. An embodiment includes a first target surface and a second target surface each disposed at an angle greater than 70 degrees with respect to an axis of rotation. An embodiment includes a first target surface and a second target surface each disposed at an angle greater than 75 degrees with respect to an axis of rotation. An embodiment includes a first target surface and a second target surface each disposed at an angle greater than 80 degrees with respect to an axis of rotation. An embodiment includes a first target surface and a second target surface each disposed at an angle between 70 degrees and 88 degrees with respect to an axis of rotation. An embodiment includes a first target surface and a second target surface each disposed at an angle that is between 75 degrees and 85 degrees with respect to an axis of rotation.

Referring to FIG. 2, a spacing between the first target surface 42 and the second target surface 46 may vary based on the geometry of the x-ray tube 18 with respect to the detector (not shown). It has been shown that separating the first target surface 42 from the second target surface 46 by a distance in the range of approximately 50% to 100% of the detector's width in the z-direction may provide a good balance between width of a field-of-view in the z-direction and image quality. Current detectors may have a detector width in the z-direction of 2 cm to 16 cm. However, it is expected that future detectors may be as wide as 30 cm. Therefore, it may be beneficial to have a first target surface separated from a second target surface by 1 cm to 30 cm or more depending upon the geometry of an x-ray tube with respect to the detector. According to an embodiment with a detector width of 17 cm in the z-direction, it has been established that a spacing between a first target surface and a second target surface of approximately 9 cm may be optimal. According to an embodiment, a first target surface may be separated from a second target surface by at least 2 cm in a z-direction. According to an embodiment, a first target surface may be separated from a second target surface by 2 cm to 30 cm in a z-direction. According to another embodiment, a first target surface may be separated from a second target surface by at least 6 cm in a z-direction. According to another embodiment, a first target surface may be displaced from a second target surface by 6 cm to 12 cm in a z-direction.

FIG. 2 shows the first target surface 42 facing generally toward the second target surface 46. However, additional embodiments may comprise a first target surface that faces generally away from a second target surface. A first target surface and a second target surface may be generally concave according to an embodiment. A first target surface and a second target surface may be generally convex according to another embodiment.

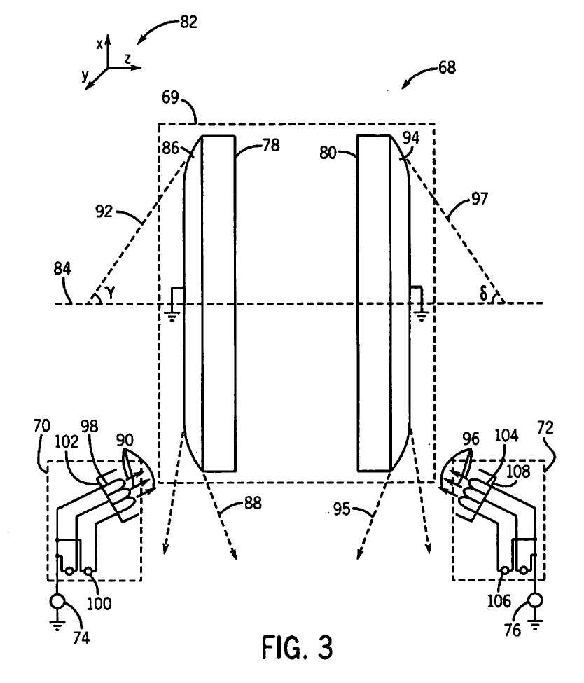

FIG. 3 is a schematic illustration of an x-ray tube 68 in accordance with another embodiment. The x-ray tube 68 represents a different embodiment of the x-ray tube 18 shown in FIGS. 1 and 2. The x-ray tube 68 includes an anode assembly 69, a first electron source 70, a second electron source 72, a first high-voltage power supply 74, and a second high-voltage power supply 76. The anode assembly 69 comprises a first anode 78 and a second anode 80. The first anode 78 is spaced apart from the second anode 80 in a z-direction as indicated by a coordinate axis 82. The first anode 78 is adapted to rotate about a rotational axis 84. The first anode 78 is tapered in a generally curved manner to define a first target surface 86 that is designed to emit a first x-ray beam 88 upon being struck by a first plurality of electrons 90 from the first electron source 70. A first dashed line 92 is tangential to the first target surface 86. The first dashed line 92 makes a first angle γ with respect to the rotational axis 84. The first angle γ of the first target surface 86 with respect to the rotational axis 84 varies based on position in the z-direction. For example, according to the embodiment illustrated in FIG. 3, the first angle γ of the first target surface 86 decreases in the positive z-direction. According to an embodiment, the first angle γ is greater than 70 degrees for at least one location on the first target surface 86. According to other embodiments, a first anode may be tapered in a generally linear manner or in both a generally curved manner and a generally linear manner to define a first target surface.

The second anode 80 is tapered in a generally curved manner to define a second target surface 94 that is designed to emit a second x-ray beam 95 upon being struck by a second plurality of electrons 96 from the second electron source 72. The second anode 80 is adapted to rotate about the rotational axis 84. A second dashed line 97 is tangential to the second target surface 94. The second dashed line 97 makes a second angle δ with respect to the rotational axis 84. The second angle δ of the second target surface 94 with respect to the rotational axis 84 varies based on position in the z-direction. For example, according to the embodiment illustrated in FIG. 3, the second angle δ of the second target surface 94 increases in the positive z-direction. According to an embodiment, the second angle δ is greater than 70 degrees for at least one location on the second target surface. According to other embodiments, a second anode may be tapered in a generally linear manner or in both a generally curved manner and a generally linear manner to define a second target surface.

According to an embodiment, the first electron source 70 comprises a first filament 98, a first current source 100, and a first control grid 102. The first filament 98 is indirectly heated by the first current source 100, causing it to emit the first plurality of electrons 90. The first high-voltage power supply 74 creates a potential difference between the first filament 98 and the first target surface 86, causing the first plurality of electrons 90 to be accelerated toward the first target surface 86. The first control grid 102 partially surrounds the first filament 98 and is connected to the first high-voltage power supply 74. The first control grid 102 is used to control or limit the flow of the first plurality of electrons 90 from the first filament 98. For example, if the first control grid 102 is kept at a high enough negative potential, all of the first plurality of electrons 90 are prevented from being accelerated towards the first target surface 86. According to an embodiment, a first plurality of electrons may form an electron beam.

According to an embodiment, the second electron source 72 comprises a second filament 104, a second current source 106, and a second control grid 108. The second electron source 72 is connected to the second high-voltage power supply 76 and functions in a manner similar to that of the first electron source 70 described previously.

The first electron source 70 and the second electron source 72 may be configured to be alternately activated. For example, at times when the first control grid 102 allows the first plurality of electrons 90 to contact the first target surface 86, the second control gird 108 is keep at a potential that does not allow any of the second plurality of electrons 96 to contact the second target surface 94. Likewise, at times when the second control grid 108 allows the second plurality of electrons 96 to contact the second target surface 94, the first control grid 102 is kept at a potential that does not allow any of the first plurality of electrons 90 to contact the first target surface 86. According to an embodiment, a separate circuit (not shown) may be attached to the first control grid 102 and the second control grid 108 in order to accurately control the potentials of the control grids 102, 108 in order to facilitate the rapid switching between the first x-ray beam 88 and the second x-ray beam 95. For example, according to an embodiment, the separate circuit may be configured to switch back and forth between activating the first x-ray beam 88 and activating the second x-ray beam 95 more than one thousand times per second.

FIG. 3 shows the first target surface 86 facing generally away from the second target surface 94. However, additional embodiments may comprise a first target surface that faces generally toward the second target surface. A first target surface and a second target surface may be generally concave according to an embodiment. A first target surface and a second target surface may be generally convex according to another embodiment.

According to an embodiment, the first electron source 70 may be configured to emit the first plurality of electrons 90 at two or more kinetic energy levels. If the first plurality of electrons 90 comprises electrons at a lower kinetic energy level, then the first x-ray beam 88 will comprise lower energy x-rays. Likewise, if the first plurality of electrons 90 comprises electrons at a higher kinetic energy level, then the first x-ray beam 88 will comprise higher energy x-rays. By acquiring data with x-rays at two or more energy levels, it is possible to get additional insight into an object being scanned. The first electron source 70 may be configured to rapidly switch between emitting the first plurality of electrons 90 at the lower kinetic energy level and emitting the first plurality of electrons 90 at the higher kinetic energy level many times during one gantry rotation. According to another embodiment, the first electron source 70 may be configured to emit the first plurality of electrons 90 at the lower kinetic energy level while one dataset is acquired and then emitting the first plurality of electrons 90 at the higher kinetic energy level while another dataset is acquired. It should be appreciated that the second x-ray source 72 may also be configured to emit the second plurality of electrons 96 at two or more kinetic energy levels in a manner similar to that described for the first electron source 70.

The spacing between a first target surface and a second target surface may depend upon the geometry of a particular CT system. For example, an embodiment may have a first target surface displaced more than 3 cm away from a second target surface in a z-direction. An embodiment may have a first target surface displaced more than 6 cm away from a second target surface in a z-direction. An embodiment may have a first target surface displaced between 4 cm and 30 cm from a second target surface in a z-direction. An embodiment may have a first target surface displaced between 6 cm and 12 cm from a second target surface in a z-direction.

According to other embodiments, an anode may be shaped to define both a first target surface and a second target surface. The anode would be rotatable about a rotational axis and the first and second target surfaces would be spaced apart in a z-direction. Each target surface may be disposed at a generally constant angle with respect to the rotational axis, or each target surfaces may be disposed at a plurality of angles with respect to the rotational axis.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. An x-ray tube comprising:
an anode assembly adapted to rotate generally about a rotational axis, the anode assembly comprising a first target surface at least partially disposed at a first angle greater than 70 degrees with respect to the rotational axis and a second target surface at least partially disposed at a second angle greater than 70 degrees with respect to the rotational axis;
wherein the first target surface is adapted to emit a first x-ray beam and the second target surface is adapted to emit a second x-ray beam.

2. The x-ray tube of claim 1, wherein the anode assembly further comprises an anode defining both the first target surface and the second target surface.

3. The x-ray tube of claim 1, wherein the anode assembly further comprises a first anode defining the first target surface and a second anode defining the second target surface.

4. The x-ray tube of claim 3, wherein the first anode and the second anode are connected by a shaft.

5. The x-ray tube of claim 1, wherein the second target surface is displaced more than 2 cm from the first target surface in a z-direction.

6. The x-ray tube of claim 1, wherein the first target surface is disposed at a generally constant angle with respect to the rotational axis.

7. The x-ray tube of claim 1, wherein the first target surface is disposed at a plurality of angles with respect to the rotational axis.

8. The x-ray tube of claim 1, further comprising an electron source configured to emit an electron beam towards at least one of the first target surface and the second target surface.

9. The x-ray tube of claim 8, further comprising an electromagnet positioned between the electron source and the first target surface, wherein the electro-magnet is configured to redirect the electron beam.

10. The x-ray tube of claim 9, wherein the electromagnet is further configured to cause the electron beam to alternate between contacting the first target surface and the second target surface.

11. The x-ray tube of claim 9, wherein the electromagnet is further configured to move the electron beam between a first position on the first target surface and a second position on the first target surface, the second position displaced from the first position in a z-direction.

12. The x-ray tube of claim 1, further comprising a first electron source configured to emit a first electron beam toward the first target surface and a second electron source configured to emit a second electron beam toward the second target surface.

13. A CT system comprising:
a gantry;
a detector assembly mounted to the gantry; and
an x-ray tube mounted to the gantry generally across from the detector assembly, the x-ray tube comprising:
an anode assembly adapted to rotate generally about a rotational axis, the anode assembly comprising a first target surface at least partially disposed at a first angle between 70 and 88 degrees with respect to the rotational axis and a second target surface at least partially disposed at a second angle between 70 and 88 degrees with respect to the rotational axis;
wherein the first target surface is adapted to emit a first x-ray beam and the second target surface is adapted to emit a second x-ray beam.

14. The CT system of claim 13, wherein the second target surface is displaced between 2 cm and 30 cm from the first target surface in a z-direction.

15. The CT system of claim 13, wherein the anode assembly further comprises a first anode defining the first target surface and a second anode defining the second target surface.

16. The CT system of claim 13, wherein the first target surface faces generally toward the second target surface.

17. The CT system of claim 13, wherein the first target surface faces generally away from the second target surface.

18. The CT system of claim 13, wherein the x-ray tube further comprises an electron source configured to emit an electron beam towards at least one of the first target surface and the second target surface.

19. The CT system of claim 13, further comprising an electro-magnet positioned between the electron source and the first target surface, wherein the electro-magnet is configured to redirect the electron beam.

20. The CT system of claim 19, wherein the electromagnet is further configured to cause the electron beam to alternate between contacting the first target surface and the second target surface.
